(19) United States
(12) Patent Application Publication
(10) Pub. No.: US 2012/0042331 A1
(43) Pub. Date: Feb. 16, 2012

(54) METHODS AND SYSTEMS FOR CONTENT INITIATION

(76) Inventor: Winston Wolf, SR., Defiance, MO (US)

(21) Appl. No.: 13/204,839

(22) Filed: Aug. 8, 2011

Related U.S. Application Data
(60) Provisional application No. 61/372,550, filed on Aug. 11, 2010.

(51) Int. Cl. H04N 7/16

(52) U.S. Cl. 725/1; 725/25

(57) ABSTRACT

Methods and systems for content initiation are described. In one embodiment, a content initiation request is received from an initiator device associated with an initiator. The content initiation request is associated with initiated content. The initiator associated with the content initiation request is verified as an authorized initiator. The broadcast request is transmitted to a broadcaster device based on verification of the initiator. The broadcast request is associated with the initiated content. Additional methods and systems are disclosed.

### RELATED APPLICATIONS

This application takes priority to U.S. Patent Application No. 61/372,550, filed Aug. 11, 2010, and entitled Methods and Systems for Content Initiation, the entire contents of which are incorporated herein by reference.

### FIELD

This application relates to methods and systems for content processing, and more specifically to methods and systems for content initiation.

### BACKGROUND

Conventional broadcast advertising commercial deployment is often based on agreements between a client that wants its message to be broadcast for any number of reasons by an entity that controls some or of all of aspects of a broadcast capability and a broadcaster wherein a client (e.g. an) advertiser is an entity that is paying to have the entity's message or product information or service information made available to broadcast television viewers. Additionally, for clients and broadcasters may have agreements where the broadcaster will electronically broadcast specific, pre-produced, full length (60 second or shorter) commercials at specific times or broadcast the content for a specific number of times.

### SUMMARY

According to one aspect, a method is provided for on demand content initiation. The method includes receiving a content initiation request at a management device from an initiator device associated with an initiator. The initiator initiates the content initiation request on the initiator device. The content initiation request is associated with initiated content. The method also includes verifying the initiator associated with the content initiation request is an authorized initiator at the management device. The method also includes identifying a broadcast time indicia from the content initiation request at the management device. The method also includes transmitting a broadcast request to a broadcaster device based on verification of the initiator. The broadcast request is associated with the initiated content and comprises the broadcast time indicia. The method further includes broadcasting the initiated content via the broadcaster device based on the broadcast time indicia.

According to another aspect, a system is provided for broadcasting content on demand. The system includes at least one processor and at least one database to store user data and content. The user data includes information regarding authorized initiators. The content includes content that may be requested for broadcast by an authorized initiator. The system also includes a plurality of modules executed by the processor to receive a content initiation request at a management device from an initiator device associated with an initiator. The initiator initiates the content initiation request on the initiator device. The content initiation request is associated with initiated content and identifies a particular initiator. The system also verifies that the particular initiator associated with the content initiation request is an authorized initiator based on the user data. The system also identifies broadcast time indicia from the content initiation request. The system also transmits a broadcast request to a broadcaster device when the particular initiator is verified. The broadcast request is associated with the initiated content and comprises the broadcast time indicia. The system further broadcast the initiated content via the broadcaster device based on the broadcast time indicia.

### BRIEF DESCRIPTION OF THE DRAWINGS

FIG. 1 is a block diagram of an example system, according to an example embodiment;

FIG. 2 is a block diagram of an example management device that may be deployed within the system of FIG. 1, according to an example embodiment;

FIG. 3 is a block diagram of an example broadcaster device that may be deployed within the system of FIG. 1, according to an example embodiment;

FIG. 4A is a block diagram of an example content initiation that may be deployed within the management device of FIG. 2 or the broadcaster device of FIG. 3, according to an example embodiment;

FIG. 4B is a screen shot of an input form with price windows;

FIG. 5 is a block diagram of a flowchart illustrating a method for content initiation, according to an example embodiment;

FIG. 6 is an illustration of an example game board, according to an example embodiment; and

FIG. 7 is a block diagram of a machine in the example form of a computer system within which a set of instructions for causing the machine to perform any one or more of the methodologies discussed herein may be executed.

### DETAILED DESCRIPTION

Example methods and systems for content initiation are described. In the following description, for purposes of explanation, numerous specific details are set forth in order to provide a thorough understanding of example embodiments. It will be evident, however, to one of ordinary skill in the art that embodiments of the invention may be practiced without these specific details.

The methods and systems for content initiation described herein enable local television advertising customers to trigger logo or other advertisement on television in near real-time via a standard web browser. The methods and systems for content initiation further enable the triggering of full commercial content and non-advertising content. Non-advertising content could include, for example, a full length television show or movie content.

The systems and methods for content initiation involve use of a remotely-triggered content storage and deployment system. Pre-approved clients or initiators engage in the on-demand placement of pre-designed, pre-approved, and pre-loaded visual and imbedded audio content on air by a participating television broadcaster. The content may be created and deployed as an overlay to the existing broadcast content or as a full screen graphic. Alternatively, the content may be created and deployed as a full length content segment.

In some embodiments, the methods and systems enable the trigger of connection to remote or local camera feeds or wireless communication devices.

In some embodiments, the methods and systems provide an easily deployable, low overhead, turnkey service that delivers increased advertising sales revenues to the broadcaster and provides a content initiator with an easy and creative way to get product information, service information, and announcements out to the public.

The methods and systems may enable the broadcaster to immediately satisfy the request of the initiator in the attempt to associate the initiator's graphic content with recent, current, or anticipated on air broadcaster content and/or current events.

The methods and systems may provide the initiator (or initiator's agent) with the ability to access mass media markets while closely controlling the temporal placement of the content and increasing return on advertising investment capital. At the Initiator's discretion and, in some embodiments, with the broadcaster's permission, the initiated content may be triggered or scheduled for triggering based on textual content provided by the broadcaster.

A manager may deploy the methods and systems so that an initiators' graphic(s) is created and then proactively triggered by the initiator for real time or near real time play through a broadcaster's system. A pre-approved Initiator may proactively initiate the deployment (placing on air) of their preapproved, pre-designed and pre-loaded broadcast content. In some embodiments, the broadcaster content over which the initiated content may be overlaid includes local news and special events aired at times when the local broadcaster has the discretion to air overlays onto the Broadcaster content.

The methods and systems provide functionality to coordinate the creation of animated broadcast graphics, coordinate the loading into the broadcaster's system, enable the advertiser to proactively engage, or trigger, a scheduled, real time or near real time placement of their content.

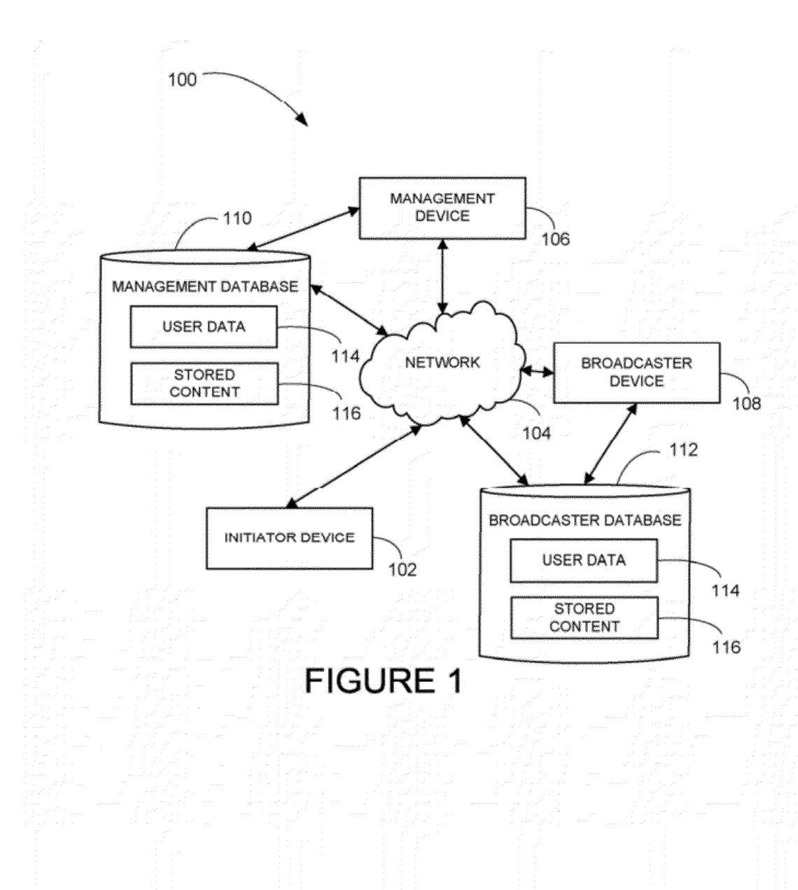

FIG. 1 illustrates an example system 100 in which content initiation may be performed. The system 100 is an example platform in which one or more embodiments of the methods may be used. However, the content initiation may also be performed on other platforms.

An operator or initiator may initiate or trigger a broadcast of content by use of the initiator device 102. In some embodiments, initiating or triggering content includes the proactive action taken by the initiator to launch pre-defined graphic deployment activity on the part of a broadcaster (or broadcaster associate).

The request for content initiation may be sent over a network 104 to a management device 106 and/or a broadcaster device 108. The initiator device 102 may be a personal computer, a mobile electronic device (e.g., a mobile phone), or the like. In general, the initiator is an entity or agent of the entity that is paying to have the initiated content displayed or otherwise broadcast by the broadcaster. For example, the initiator may be an advertiser that pays to have initiated content broadcast by the broadcaster or maybe an employee of the company.

The initiation of the content enables the initiator to have “on demand” content. “On demand” generally refers to the ability of the initiator to have the graphic content or other type of initiated content broadcast at a time convenient or opportunistic to the initiator.

The initiated content includes, by way of example, a company logo or other specially created graphic or message that can be aired by the broadcaster at the time the initiator triggers deployment. The initiated content may be a full screen commercial, text provided via broadcaster's moving text display system or a crawl, a partial screen overlay or a bug, or the like.

The initiated content may be audio and, in some embodiments, may include imbedded audio. Imbedded audio generally includes to sound or sound effects that are built into the initiated content and triggered as part of the initiated content.

The network 104 over which the initiator device 102 and the management device 106 and/or the broadcast device 108 may communicate include, by way of example, a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

In general, the manager operates the management device 106 and the broadcaster operates the broadcaster device 108. The manager may solicit new initiators and manage existing initiators to initiate their content (e.g., advertisements) to be broadcast by the broadcaster. The broadcaster may also be the manager (e.g., when the devices 106/108 are combined into a singe device.)

In general, the broadcaster includes entities that utilize terrestrial, cable, satellite, mobile, web or other transmission technologies and entities that control the content and deployment of the content being displayed on public information signage and sports venue information and entertainment displays. The broadcasters may also use other technologies to enable the transmission and display of initiated content.

The broadcaster may manage a single broadcast station or a broadcast network consisting of multiple broadcast stations. The broadcaster may broadcast its content through the broadcaster device 108, or may broadcast its content through a different device. Likewise, the initiated content may be similarly broadcast.

The broadcaster may be associated with broadcast stations, independent stations, and/or network owned stations. Additional broadcast technologies that may be used include: Cable, satellite, and web and radio/satellite radio technology.

The broadcaster may be associated with venues using JumboTron™ and Daktronics™ type of large display boards. Examples include sporting venues supporting professional, minor league and university organizations and digital signage/private networks such as those deployed within McDonald's and Walmart stores.

Broadcasts made by the broadcaster include, but are not limited to, television broadcast, cable, public venue display, sports facilities display, digital signage display, satellite, narrowcast, web, and mobile network transmission and reception systems.

In some embodiments, the broadcaster may approve initiators that seek to have initiated content broadcast. Thus, even though the manager may manage the relationship with the initiators, the initiators may be unable to have the broadcaster broadcast content initiated by the initiator until the initiators are approved.

When used in the system 100, the management device 106 generally manages at least some of the communication between the initiator device 102 and the broadcaster device 108. For example, a request for broadcast of content may be received on the management device 106 from the initiator device 102. The management device 106 may then appropriately communicate with the broadcaster device 108 to request that the content be broadcast.

When the management device 106 is not used in the system 100, the initiator device 102 may communicate directly with the broadcaster device 108 to request a broadcast of content.

The management device 106 and the broadcaster device 108 may be separate devices or combined into a single device in the system 100. The management device 106 may be in a networked relationship with the broadcaster device 108, in a client-server relationship with the broadcaster device 108, a peer-to-peer relationship with the broadcaster device 108, or in a different type of relationship with the broadcaster device 108.

In one embodiment, the management device 106 is a single device. In another embodiment, the management device 106 may include multiple devices. For example, the management device 106 may include multiple computer systems in a cloud computing configuration. The broadcaster device 108 may be similarly deployed as a single device or multiple devices in the system 100.

The management device 106 may communicate with a management database 110. The management database 110 may include user data 114 and stored content 116. In general, the user data 114 includes information regarding initiators associated with the system 100. The stored content 116 includes content that may be requested for broadcast by the initiator.

In some embodiments, the broadcaster may be able to access the management device 106 to check on pending approvals triggered and scheduled initiated content.

The initiator may upload content for initiation that is stored in the broadcaster database 112 as the stored content 116 by the broadcaster device 108.

The broadcaster device 108 may communicate with a broadcaster database 112. The broadcaster database 112 may include the user data 114 and the stored content 116. The user data 114 and/or the stored content 116 may be the same as or different to the user data 114 and the stored content 116 stored in the management database. In one embodiment, the management device 106 and the broadcast device 108 communicate with a single database.

In some embodiments, the initiator uploads content for initiation that is stored in the management database 110 as the stored content 116 by the management device 106. The management device 106 may transmit the stored content 116 to the broadcaster device 108 that is stored in the broadcaster database 112. The management device 106 may notify the broadcaster device 108 of the updated and/or new stored content 116 and the broadcaster device 108 may retrieve the stored content 116 from the management database 110. In one embodiment, the broadcaster or the broadcast device 108 may approve of the stored content 116 prior to allowing it to be broadcast.

While the system 100 displayed in FIG. 1 reflects a single initiator device, a single management device, and a single broadcaster device, multiple initiator devices, multiple management devices, and/or multiple broadcaster devices may be deployed in the system 100.

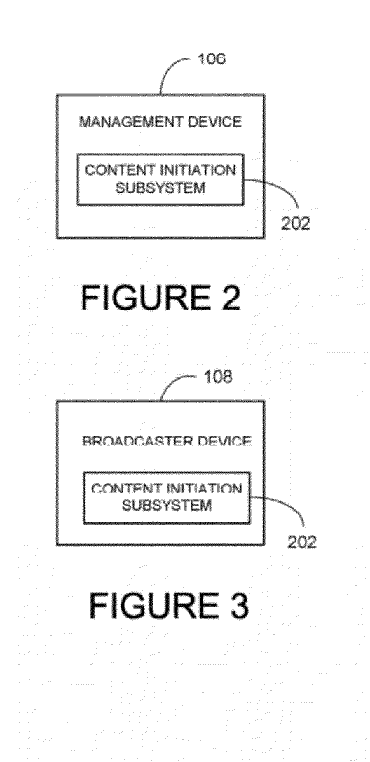

FIG. 2 illustrates an example management device 106 that may be deployed in the system 100 (see FIG. 1), or otherwise deployed in another system. The management device 106 is shown to include a content initiation subsystem 202. The content initiation subsystem 202 enables an initiator to request content to be broadcast.

In some embodiments, the content initiation subsystem 202 is a single subsystem while in other embodiments the content initiation subsystem 202 is multiple subsystems. For example, a first subsystem may be deployed as a pre-routing tool and a second subsystem may be deployed as a detailed router or industrial router. In one embodiment, the pre-routing tool generates and adds the pre-routes to the physical design before the second subsystem generates and adds the remaining routes to the pre-routed physical design.

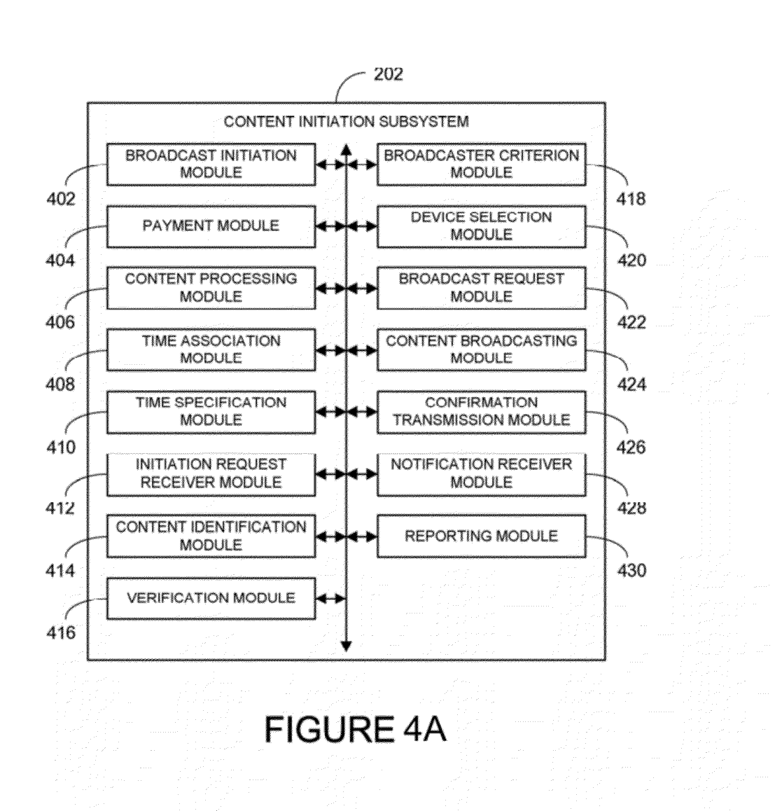

FIG. 3 illustrates an example broadcaster device 108 that may be deployed in the system 100 (see FIG. 1), or otherwise deployed in another system. The broadcaster device 108 is shown to include the content initiation subsystem 202 (see FIG. 2).

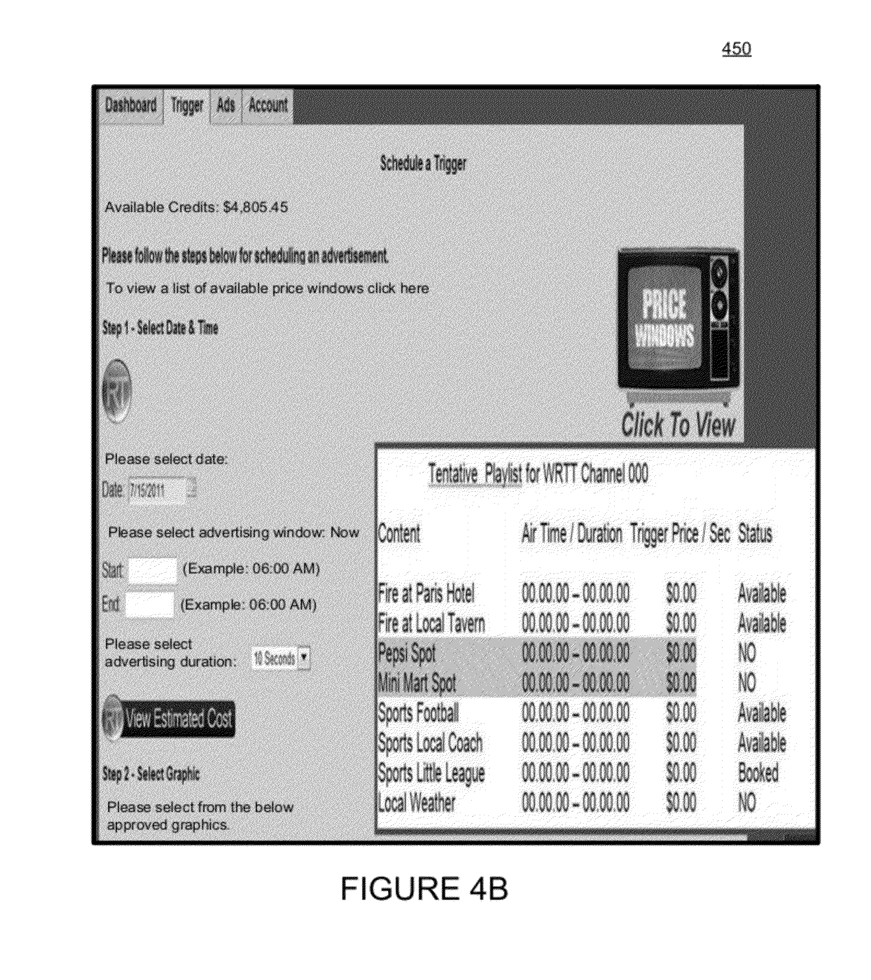

FIG. 4A illustrates an example content initiation subsystem 202 that may be deployed in the management device 106, the broadcaster device 108, or otherwise deployed in another system. One or more modules are included in the content initiation subsystem 202 to create a physical design of a chip. In this example, the modules of the content initiation subsystem 202 include a broadcast initiation request module 402, a payment module 404, a content processing module 406, a time association module 408, a time specification module 410, an initiation request receiver module 412, a content identification module 414, a verification module 416, a broadcaster criterion module 418, a device selection module 420, a broadcast request module 422, a content broadcasting module 424, a confirmation transmission module 426, a notification receiver module 428, and a reporting module 430. Other modules may also be included. In various embodiments, the modules may be distributed so that some of the modules may be deployed in the management device 106 and some of the modules may be deployed in the broadcaster device 108. In one particular embodiment, the content initiation subsystem 202 includes a processor, memory coupled to the processor, and a number of the aforementioned modules deployed in the memory and executed by the processor.

In some embodiments, the broadcast initiation request module 402 receives a broadcast initiation request to initiate content broadcasts. The broadcast initiation request may be received from the initiator, the initiator device 102, or both. The broadcast initiation request and/or additional information received may be used to setup an account on behalf of the initiator with the manager, the broadcaster, or both. The received information may include personal information, an e-mail address, a phone number, payment information, content, or the like.

The initiator may be authorized in response to receipt of the broadcast initiation request by the broadcast initiation request module 402.

The payment module 404 configures payment options for the initiator. The payment module 404 may check the credit of the initiator based on receipt of the request to initiate content broadcasts. The payment module 404 may receive payment and establish credit for the initiator. The payment module 404 may receive payment information (e.g., a credit card number, a bank account number, etc.) for the initiator. In some embodiments, the payment module 404 transmits a credit notification to the initiator device 102 based on checking of the credit.

The payment module 404 may include a billing/accounting system for managing payments/credit accounts and revenue (e.g., advertisement revenue) associated with broadcasting initiated content.

In some embodiments, broadcasters may have a table broken in time increments (e.g., 15 minute increments) that identifies the times of day that content may be initiated by the initiator and a cost for initiated the content during the time period. FIG. 4B depicts an exemplary screen shot of an trigger input form 450 that can be used an initiator and/or manager to select and view times of day and time periods during which content may be initiated.

In some embodiments, the payment module 404 may be used to establish a credit limit for a particular initiator. The credit limit may be established by the manager, the broadcaster, or both. The credit limit may be for a particular broadcaster or all broadcasters associated with the manager.

An example of the use of the payment module 404 for account setup and approval cycle is as follows. Initiator credit information is captured and credit worthiness is established by the payment module 404. The agreement to the terms and conditions is made between the initiator and the manager and/or the broadcaster. The terms and conditions may include a price for providing custom animated or still graphics, payment terms, subscription fees, set up charges and other specific contractual agreements.

The initiator agrees with the broadcaster's terms and conditions. In some embodiments, the broadcaster defines which programming and what timeframes would be open to initiator triggered on demand graphics advertising activities. In some embodiments, the terms and conditions of the agreement between the initiator and the broadcaster and manager include the length of time the client graphic will air, the maximum amount of time between request to air and actual airing, the bug size (e.g., measured as a percentage of broadcaster screen used), and the placement position of the client graphic.

The broadcaster may confirm that airing initiated content from initiator is not in violation of any existing broadcaster agreements. If the initiator is approved by broadcaster, the information from the initiator is received by the management device 106 and/or the broadcaster device 108 and final setup charges are made. The initiator may be charged any set up, subscription, and graphics creation fees by the payment module 404 and then may be provided with instructions regarding the steps to build the client graphic or graphics.

The content processing module 406 receives content from the initiator device. The received content may be the initiated content or may be used as a basis for the initiated content. For example, the received content may be formatted to create the initiated content.

The content processing module 406 may associate a content identifier with the initiated content and transmit the content identifier to the initiator device 102 and/or associate initiated content with broadcast content.

The content processing module 406 may access initiated content associated with the content initiation request based on the content initiation request.

The initiated content received by the content processing module 406 may be selected based on receipt of the content initiation request.

An example of the use of the content processing module 406 for content design, creation, and approval is as follows.

If available to the initiator, graphic art will be provided by the initiator to the content processing module 406 and the initiated content may be built under the terms and conditions previously agreed and in the appropriate format for the broadcaster's graphics ingestion, storage, and play out system.

Upon completion of the initiated content, the initiated content example may be provided by the content processing module 406 to the initiator for final approval and then provided to broadcaster in the broadcaster compatible format for broadcaster approval. Upon approval of graphic by the broadcaster, the final initiated content may be provided a unique identifier number and placed in the stored content 116 and linked to the user data 114 and be made available for ingestion into broadcaster graphics system. Upon ingestion of the initiated content, the broadcaster holds client approved initiated content until a request for triggering or initiation is received.

Upon completion of design and approval cycle, the broadcaster device 108 ingests pre approved content and therefore makes the pre-approved content available to the broadcaster device 108 or a broadcaster system workflow process example.

The time association module 408 associates initiated content with a particular time.

The time specification module 410 receives a broadcast time specification. The broadcast time specification may specify default timing, may be based on current day or time be based on content, or may make a calendar available for selection by the initiator. In one embodiment, the broadcast time specification includes a specific time and a time delay.

The initiator initiates a request on the initiator device 102 that the initiated content be broadcast. The content initiation request is then transmitted over the network 104. The initiation request receiver module 412 receives the content initiation request from the initiator device 102. The content initiation request is a requested trigger for content to be broadcasted by the broadcaster.

The content initiation request may identify the initiated content or include the initiated content. For example, the content initiation request may include a numeric identifier that identifies the desired content to be initiated among a number of different content. The numeric identifier may be a number specific to the initiator, or may be a global number that uniquely identifies the content among all available content.

If the content initiation request does not identify or include the initiated content, a content identification module 414 may select the initiated content. The initiated content may be selected based on time of day, based on previously broadcast content, based on current broadcast content, based on future broadcast content, or the like.

The content initiation request may include a broadcast time indicia. The broadcast time indicia may indicate a time at which the initiated content should be broadcast. The time may be a specified time (e.g., broadcast the initiated content at 5:24 p.m.), a time delay (e.g., broadcast the initiated content in 10 minutes), a time range (e.g., broadcast the initiated content during a particular program), or the like.

The content initiation request may include a content presentment time indicator. The content presentment time indicator indicates an amount of time that the initiated content is to be presented.

The initiator associated with the content initiation request is verified by the verification module 416. The verification module 416 either verifies that the initiator is an authorized initiator or fails to verify the initiator (e.g., the initiator is an unauthorized initiator). Verification may include verifying access credentials such as user name and password, verifying that an e-mail address is associated with the initiator, verifying that a telephone number associated is associated with the initiator, or the like. In some embodiments, verification of the initiator is based on authorization of the initiator.

In some embodiments, the verification module 416 identifies the initiator associated with the content initiation request. The verification of the initiator may then be based on identification of the initiator.

The broadcaster criterion module 418 determines that the content initiation request meets broadcaster criterion. The broadcaster criterion may include a blackout period, a content type restriction period, or the like.

The device selection module 420, when deployed, selects the broadcaster device 108 where the initiated content may be displayed. A single broadcaster device or multiple broadcaster devices may be selected. In one embodiment, selection of the broadcaster device is based on the content initiation request. For example, the content initiation request may specify the broadcaster device 108 for selection. In another embodiment, a broadcaster device selection is received (e.g., from the initiator). In yet another embodiment, selecting the broadcaster device includes analyzing content associated with the broadcaster device 108 and additional broadcaster devices and selecting the broadcaster device 108 among the available broadcaster devices based on the analysis of the content. The broadcaster device 108 may otherwise be selected.

In some embodiments, the broadcast request module 422 transmits a broadcast request to the broadcaster device 108. Once the broadcaster device 108 receives the broadcast request, the broadcaster may then broadcast the initiated content. The initiated content may be broadcast from the broadcaster device 108 or another device associated with the broadcaster. In one embodiment, the content broadcasting module 424 broadcasts the initiated content.

In some embodiments, the broadcast request is transmitted to the broadcaster device 108 based on a time indicia.

In some embodiments, the broadcast request includes a content identifier that identifies the initiated content. The content identifier included with the broadcast request may be the same content identifier included within the content initiation request or may be a different content identifier.

In some embodiments, the broadcast request includes a content presentment time indicator. The content presentment time indicator included with the broadcast request may be the same content presentment time indicator included within the content initiation request or may be a different content presentment time indicator. The broadcast request may include billing information associated with the initiator and/or the initiated content.

In some embodiments, transmission of the broadcast request is based on the verification of the initiator and selection of or access to the initiated content.

In some embodiments, the content initiation request includes billing information associated with the initiator. The billing information may include initiator account identification, credit card payment information, pre-payment information, or the like.

In some embodiments, the broadcast request is transmitted when the initiator has passed a credit check, when payment information has been received, when pre-payment has been received, or the like.

The broadcast request may include a broadcast time indicia. The broadcast time indicia of the broadcast request may be the same broadcast time indicia as the content initiation request or may be a different broadcast time indicia.

In other embodiments, at least some of the modules are deployed in the broadcaster device 108 and the content broadcasting module 424 broadcasts the initiated content based on verification of the initiator.

In some embodiment, transmission of the broadcast request is based on the verification of the initiator and selection of the broadcaster device, receipt of the broadcaster device selection, and/or a determination that the content initiation request meets broadcaster criterion.

The broadcast request may include a time based on the time associated by the time association module 408.

In some embodiments, the broadcast request is associated with the broadcast time specification and/or with broadcast content. In some embodiments, the broadcast request is transmitted based on the broadcast time specification.

The payment module 404 receives payment based on transmitting the broadcast request. The payment may be received from the initiator, the broadcaster, or combinations thereof. In some embodiments, the payment is received over the network 104 from the initiator device 102, the broadcaster device 108, or combinations thereof.

The payment module 404 may operate by the use of money and/or credit. For example, a number of credits may be purchased by the initiator and an appropriate number of credits may be deducted from an account of the initiator based on a number of times that initiated content has been broadcast, an amount of time that the initiated content has been broadcast, times of day when the initiated content was broadcast, particular days when the initiated content was broadcast, and the like.

The confirmation transmission module 426 may transmit a broadcast request confirmation to the initiator device 102 based on transmission of the broadcast request and/or a broadcast confirmation to the initiator device 102 based on receipt of the broadcast completion notification.

The notification receiver module 428 receives a broadcast completion notification from the broadcaster device 108 based on transmitting the broadcast request.

The reporting module 430 generates a report based on transmitting the broadcast request to the broadcaster device 108 and transmitting additional broadcast requests.

In some embodiments, the reporting module 430 may be used by the broadcaster to reconcile the initiated content that has been broadcast. Appropriate adjustment may be made to a credit account of an initiator based on the initiated content that has been broadcast.

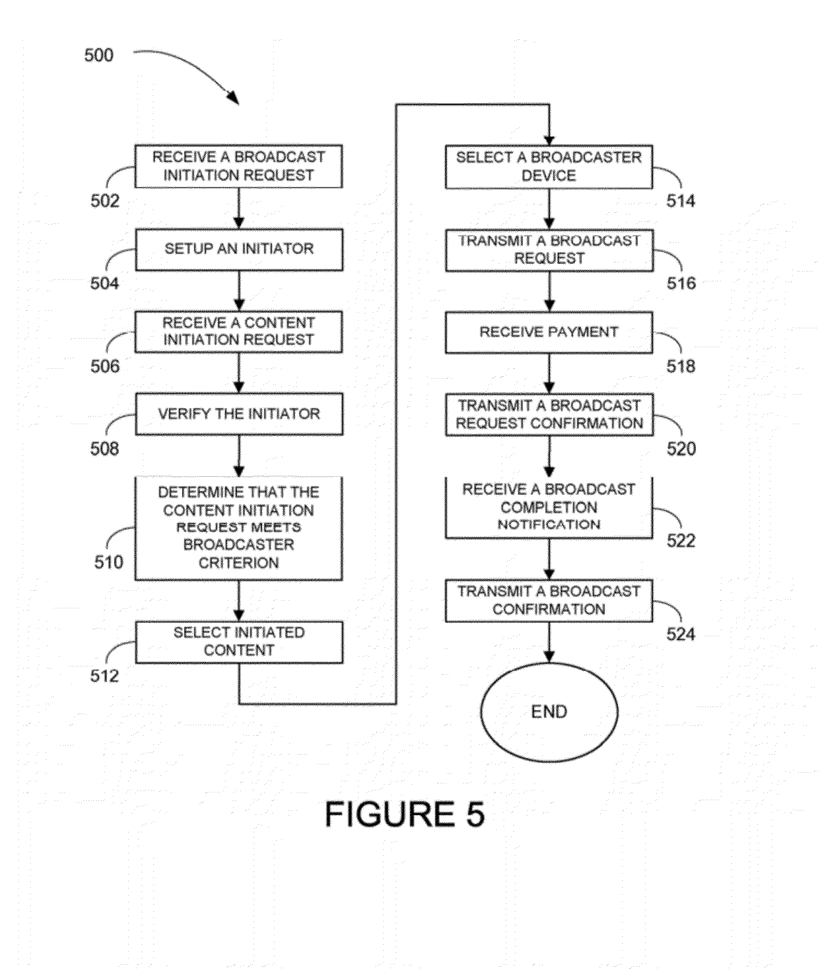

FIG. 5 illustrates a method 500 for content initiation according to an example embodiment. The method 500 may be performed by the management device 106 or the broadcaster device 108 of the system 100 (see FIG. 1), or may be otherwise performed.

A broadcast initiation request may be received at block 502 to initiate content broadcasts. In some embodiments, the initiator is authorized in response to receipt of the broadcast initiation request.

The initiator may be setup at block 504. The setup may include configuring payment options, receiving content, associating initiated content, receiving a broadcast time specification, and the like.

A payment option for the initiator may be configured at block 504. In some embodiments, the configuration may include checking the credit of the initiator. In some embodiments, the configuration may include receiving payment information associated with the initiator. In some embodiments, a credit notification that advises on credit status is transmitted to the initiator device 102.

Content may be received from the initiator device 102 at block 504. The initiated content may be based on the received content. For example, the initiated content may be the received content or the received content may be formatted to create the initiated content. In some embodiments, a content identifier is associated with the initiated content and the content identifier is transmitted to the initiator device 102.

Initiated content may be associated with a particular time at block 504. A broadcast time specification may be received at block 504.

A content initiation request is received at block 506. The content initiation request may be in the form of a SMS, an e-mail, a web request, or the like. In some embodiments, the content initiation request is received from the initiator device 102. In other embodiments, the content initiation request may be received from a mobile device, a telephone, a letter.

In some embodiments, the content initiation request identifies the initiated content. In some embodiments, the content initiation request includes the initiated content, a broadcast time indicia, a content presentment time indicator, and/or billing information associated with the initiator.

The initiator associated with the content initiation request is verified as an authorized initiator at block 508. In some embodiments, verification of the initiator may be based on authorization of the initiator.

In some embodiments, the initiator associated with the content initiation request is identified and verification of the initiator is based on identification of the initiator.

A determination may be made at block 510 that the content initiation request meets broadcaster criterion. A single broadcaster criterion or multiple broadcaster criteria may be used in the determination. If a determination is made that the content initiation request does not meet the broadcaster criterion, a notice may be transmitted to the initiator to advise that the broadcaster criterion has not been met and the method 500 may terminate. In some embodiments, the specifics of why the broadcaster criterion has not been met may be provided. If a determination is made that the content initiation request meets the broadcaster criterion, the method 500 may proceed to block 512.

The initiated content may be selected at block 512 based on receipt of the content initiation request.

At block 514, the broadcaster device 108 may be selected among available broadcaster devices. In one embodiment, selection of the broadcaster device 108 is based on the content initiation request. In another embodiment, a broadcaster device selection is received and selection of the broadcaster device is based on receipt of the broadcaster device selection. In yet another embodiment, content associated with available broadcaster devices is analyzed and the broadcaster device 108 is selected among the available broadcaster devices based on analysis of the content.

A broadcast request is transmitted to the broadcaster device 108 at block 516 based on verification of the initiator. In some embodiments, the broadcast request is transmitted to the broadcaster device 108 based on a broadcast time indicia, a broadcast time specification, and/or selection of the initiated content.

In some embodiments, initiated content associated with the content initiation request is accessed based on the content initiation request and the broadcast request is transmitted based on the verification of the initiator and access of the initiated content.

The broadcast request may be based on the verification of the initiator, selection of the broadcaster device 108, and/or a determination that the content initiation request meets broadcaster criterion.

The broadcast request is associated with the initiated content. In some embodiments, the broadcast request includes a content identifier, the initiated content, a broadcast time indicia, a content presentment time indicator, and/or billing information associated with the initiator. In one embodiment, the broadcast request may be further associated with the particular time, a broadcast time specification, or both.

In some embodiments, the initiated content may be broadcast at block 516 instead of transmitting the broadcast request to the broadcaster device 108. For example, this operation may occur when the method 500 is performed on the broadcaster device 108.

At block 518, payment may be received based on the operations performed at block 516.

A broadcast request confirmation may be transmitted to the initiator device 102 at block 520 based on transmitting the broadcast request.

A broadcast completion notification may be received from the broadcaster device 108 at block 522. A broadcast confirmation may be transmitted to the initiator device 102 at block 524 based on receipt of the broadcast completion notification.

In some embodiments, a report may be generated. The report may be generated based on the transmission of the broadcast request and other broadcast requests.

An example implementation of the method 500 is as follows.

The implementation, in some embodiments, may only occur after the initiator account is set up and credit approval and or credit card authorizations are complete and the initiator and associated graphic(s) are approved by the broadcaster. The initiator currently views broadcast content being provided by a participating broadcaster. The initiator may determine that, based on current participating broadcaster content or anticipated broadcaster content it would be opportunistic to associate graphic(s) with currently airing or anticipated airing of broadcast content.

The initiator remotely triggers by communicating to the content initiation subsystem 202. The content initiation subsystem 202 may authenticate the client identification and confirm the graphic number. The broadcaster may then be alerted to air the specified graphic for the time period under the terms and conditions previously arranged

When the initiator views currently airing broadcast content being provided by a participating broadcaster and determines that, based on current participating broadcaster content or anticipated broadcaster content, it would be opportunistic to associate client graphic(s) with currently airing content or anticipated content. The initiator remotely triggers the content by communicating with the initiation request receiver module 412.

The content initiation subsystem 202 may authenticate the client identification and confirm the unique identification number of the client graphic. The content initiation subsystem 202 may alert the broadcaster to air the specified graphic for the time period under the terms and conditions previously arranged.

Upon completion of the instruction to air the specified graphic for the specific time within the specified window of opportunity, the content initiation subsystem 202 may facilitate payment to the broadcaster through the payment module 404 and appropriate reporting to the initiator through the confirmation transmission module 426 and/or the reporting module 430.

Example implementations of the above mentioned systems and methods are as follows.

### Example 1

Fred, owner of Fred's House of Tires agrees to terms and conditions and pricing policies of the present invention and provides his Fred's House of Tires logo content to the present invention. Credit and payment arrangements are coordinated. A participating broadcaster-compatible still or animated graphic is created as initiated content. Fred has previously agreed to specified terms and conditions of the broadcaster and the broadcaster has previously agreed to air Fred's House of Tires logo at a specified percentage of the broadcast video frame, for a specified amount of time, and within a specified amount of time after receipt of request from the Fred (acting as initiator).

As Fred watches the news, there is a story about tire safety. Fred determines that he wants the viewers to associate Fred's House of Tires with tire safety, as detailed in the news story. Fred contacts the system and orders initiated content in the form of an as soon as possible graphic overlay. Within the timeframe previously agreed, Fred sees his initiated on air. He gets timely placement, the broadcaster gets revenue, and the viewer of the broadcast potentially associates Fred's House of Tires with the broadcaster content.

Fred receives an invoice or an immediate posting to his credit card, depending on the terms and conditions previously arranged.

Alternatively, Fred's marketing agency could have previously agreed to include the methods and systems as a part of the marketing agency's services. In this case, the marketing agency may act as Fred's agent and coordinate the initiation of content.

### Example 2

National news about volcanic eruption and impending ash cloud is a top story. Surgical_Mask.com corporate headquarters has previously set up account and graphic(s) within the above methods and system. Surgical Mask takes advantage of the current news stories and orders airing of Surgical_Mask.com graphic, offering the temporal placement on behalf of the local retailer/distributor.

In some embodiments, if the initiator assumes that there will be a story, the initiator can order placement based on anticipated news of the day.

### Example 3

MM Marketing Company builds a client-centric marketing plan to help their client introduce a new product offering. MM Marketing Company makes arrangements with the broadcaster and, via the methods and systems, remotely triggers or initiates advertising content when the advertiser feels the best opportunity exists.

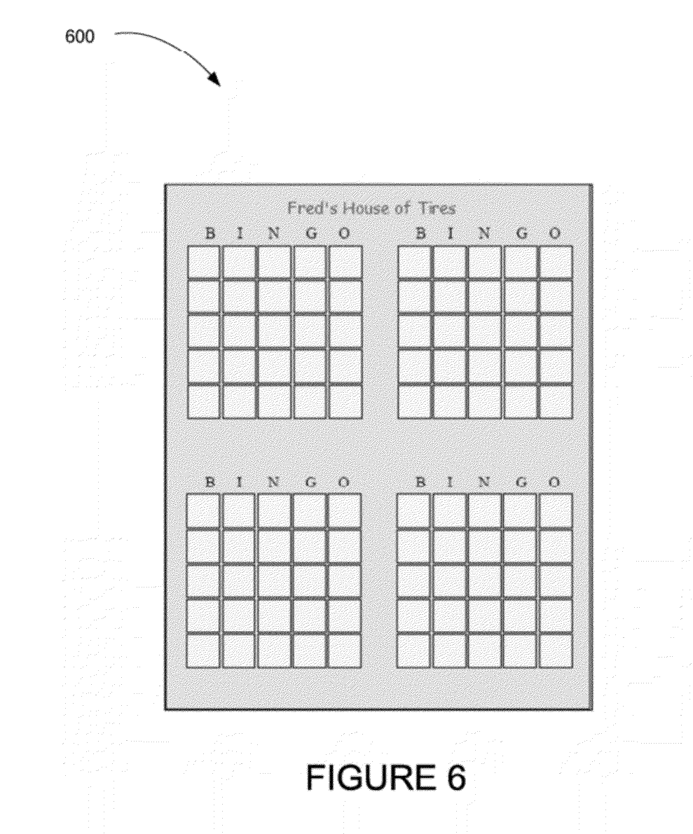

FIG. 6 illustrates an example game board 600, according to an example embodiment. The game board 600 may generated for display by a device receiving a broadcast from the broadcaster device 108 or another device operated by the broadcaster, or may be otherwise be used.

In some embodiments, use of the game board 600 enables a broadcaster to focus on “hyperlocal” activity and supports additional community involvement. In some embodiments, use of the game board 600 offers additional market coverage for participating local advertisers and game sponsors. Participating broadcasters will benefit. In some embodiments, use of the game board 600 encourages viewers to watch the participating broadcasters' programming.

The game board 600 is shown in the form of bingo like game cards. A number of entities may be involved with the use of the game card 600. Examples entities and their participation are described below.

The initiator is the entity that pays to have their logo or other initiated content displayed on broadcast television. The initiator has a fee based option to participate in the weekly bingo like game. Initiators that opt in to the bingo like game may have their logos included on the weekly cards.

A game sponsor for the bingo like game is an entity that pays for and arranges for the printing, web site, or other distribution of the weekly game cards. The game sponsor may have the responsibility to customize the game cards to include the game sponsor's company name, logo, web site phone number, and the like. The game sponsor may also be responsible for the receipt and confirmation of winning game cards as well as the distribution of any prizes subject to any applicable State or Federal Gaming laws.

The broadcaster will broadcast the initiator's logo or other initiated content through the broadcaster's television broadcast system.

Players may acquire the weekly game cards from the game sponsor and watch the broadcaster's programming, taking note of the logos or other initiated content that match the designs on the weekly game card(s). Upon meeting the specified criterion for winning (complete row, complete card, etc.), the player may contact the game sponsor for confirmation and distribution of any claimed prizes.

The manager may collect participation fees from the initiators as well as fees from the game sponsor(s). In exchange, the manager may provide the weekly games card data to the participating game sponsors for printing and distribution. The manager may provide the game sponsor with access to a real time list of currently aired logos to compare to the winning claimant. The manager may use the associated fees to contract with a 3rd party to coordinate (and be responsible for) the game operations.

The game board 600 is an example version of a game board that may be generated. Other versions of the game board 600 may also be generated and used.

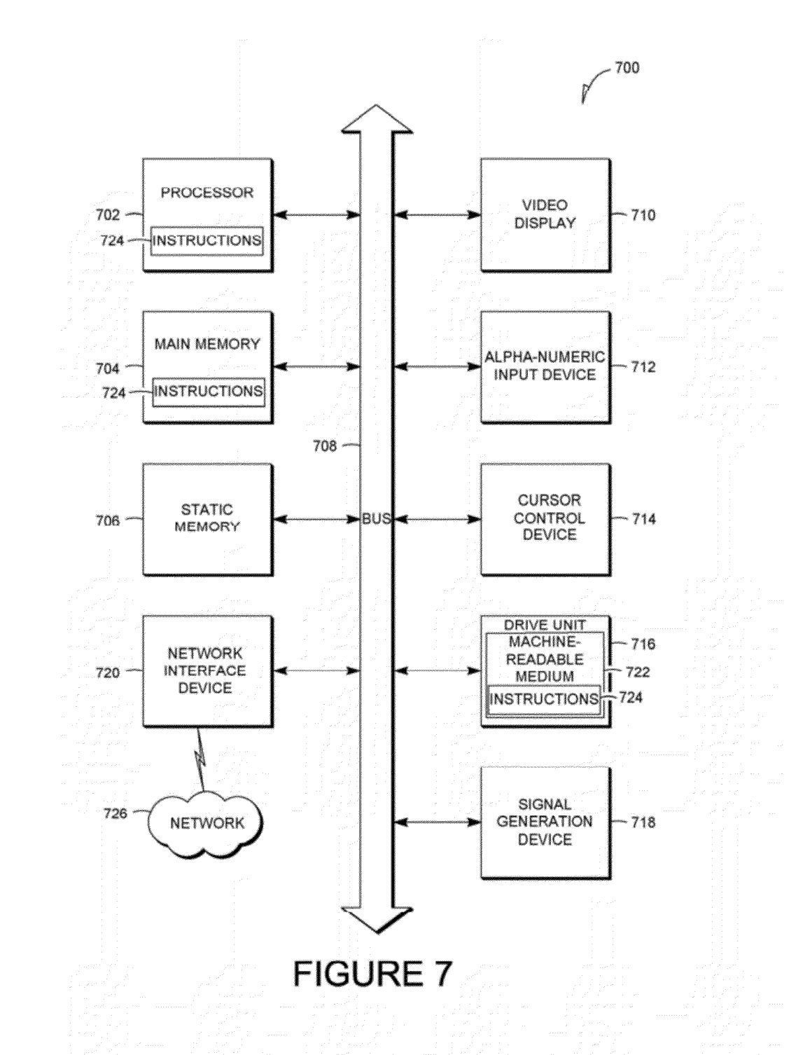

FIG. 7 shows a block diagram of a machine in the example form of a computer system 700 within which a set of instructions may be executed causing the machine to perform any one or more of the methods, processes, operations, or methodologies discussed herein. The initiator device 102, the management device 106, and/or the broadcast device 108 may include the functionality of the one or more computer systems 700 (see FIG. 1).

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 712 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a drive unit 716, a signal generation device 718 (e.g., a speaker) and a network interface device 720.

The drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 712 during execution thereof by the computer system 700, the main memory 704 and the processor 712 also constituting machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention. The term “machine-readable medium” shall accordingly be taken to include, but not be limited to, solid-state memories, and optical media, and magnetic media.

Certain systems, apparatus, applications, or processes are described herein as including a number of modules. A module may be a unit of distinct functionality that may be presented in software, hardware, or combinations thereof that is executed by a processor (e.g., processor 712). When the functionality of a module is performed in any part through software, the module includes a machine-readable medium. The modules may be regarded as being communicatively coupled.

In an example embodiment, a content initiation request is received from an initiator device associated with an initiator. The initiator has initiated the content initiation request on the initiator device. The content initiation request is associated with initiated content. The initiator associated with the content initiation request is verified as an authorized initiator. A broadcast request is transmitted to a broadcaster device based on verification of the initiator. The broadcast request is associated with the initiated content.

In an example embodiment, a content initiation request is received from an initiator device associated with an initiator. The initiator has initiated the content initiation request on the initiator device. The content initiation request is associated with initiated content. The initiator associated with the content initiation request is verified as an authorized initiator. The initiated content is broadcast based on verification of the initiator.

Thus, methods and systems for content initiation have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

Various activities described with respect to the methods identified herein can be executed in serial or parallel fashion. Although “End” blocks are shown in the flowcharts, the methods may be performed continuously.

What is claimed is:

1. A method comprising:
receiving a content initiation request at a management device from an initiator device associated with an initiator, the initiator having initiated the content initiation request on the initiator device, the content initiation request being associated with initiated content;
verifying the initiator associated with the content initiation request is an authorized initiator at the management device;
identifying a broadcast time indicia from the content initiation request at the management device;
transmitting a broadcast request to a broadcaster device based on verification of the initiator, the broadcast request associated with the initiated content and comprising the broadcast time indicia; and
broadcasting the initiated content via the broadcaster device based on the broadcast time indicia.

2. The method of claim 1, wherein the content initiation request identifies the initiated content and the broadcast request includes a content identifier that identifies the initiated content.

3. The method of claim 1, wherein the content initiation request includes the initiated content.

4. The method of claim 1 wherein the broadcast request includes the initiated content.

5. The method of claim 1, further comprising:
selecting the broadcaster device,
wherein transmitting the broadcast request is based on the verification of the initiator and selection of the broadcaster device.

6. The method of claim 5, wherein selection of the broadcaster device is based on the content initiation request.

7. The method of claim 5, further comprising:
receiving a broadcaster device selection,
wherein selection of the broadcaster device is based on receipt of the broadcaster device selection.

8. The method of claim 5, wherein selecting the broadcaster device comprises:
analyzing content associated with a plurality of available broadcaster devices,
selecting the broadcaster device among the plurality of available broadcaster devices based on analysis of the content.

9. The method of claim 1, wherein the content initiation request includes a first broadcast time indicia and the broadcast request includes a second broadcast time indicia, the second broadcast time indicia being identified based on the first broadcast time indicia.

10. The method of claim 9, wherein the second broadcast time indicia is the same indicia as the first broadcast time indicia.

11. The method of claim 1, wherein the content initiation request includes a first broadcast time indicia and the broadcast request is transmitted to the broadcaster device based on a second broadcast time indicia, the second broadcast time indicia being identified based on the first broadcast time indicia.

12. The method of claim 1, wherein the content initiation request includes a content presentment time indicator.

13. The method of claim 1, wherein the broadcast request includes a content presentment time indicator.

14. The method of claim 1, wherein the content initiation request includes billing information associated with the initiator.

15. The method of claim 1, wherein the broadcast request includes billing information associated with the initiator.

16. The method of claim 1, further comprising:
determining that the content initiation request meets broadcaster criterion,
wherein transmitting the broadcast request is based on the verification of the initiator and a determination that the content initiation request meets broadcaster criterion.

17. The method of claim 16, wherein the broadcaster criterion includes a blackout period, a content type restriction period, or combinations thereof.

18. The method of claim 1, further comprising:
receiving a broadcast initiation request to initiate content broadcasts.

19. The method of claim 18, further comprising:
authorizing the initiator in response to receipt of the broadcast initiation request,
wherein verification of the initiator is based on authorization of the initiator.

20. The method of claim 19, further comprising:
checking credit of the initiator based on receipt of the request to initiate content broadcasts,
wherein transmitting the broadcast request is based on checking of the credit.

21. The method of claim 20, further comprising:
receiving payment information associated with the initiator,
wherein checking the credit is based on receipt of the payment information.

22. The method of claim 21, further comprising:
transmitting a credit notification to the initiator device based on checking of the credit.

23. The method of claim 1, further comprising:
receiving content from the initiator device,
wherein the initiated content is based on the received content.

24. The method of claim 23, wherein the initiated content is the received content.

25. The method of claim 23, further comprising:
formatting the received content to create the initiated content.

26. The method of claim 25, further comprising:
associating a content identifier with the initiated content; and
transmitting the content identifier to the initiator device.

27. The method of claim 26, further comprising:
associating initiated content with a particular time,
wherein the broadcast request is associated with the particular time.

28. The method of claim 27, further comprising:
receiving a broadcast time specification,
wherein the broadcast request is associated with the broadcast time specification.

29. The method of claim 28, wherein the broadcast time specification includes a specific time and a time delay.

30. The method of claim 29, further comprising:
receiving a broadcast time specification,
wherein transmitting the broadcast request is based on the broadcast time specification

31. The method of claim 30, further comprising:
associating initiated content with broadcast content,
wherein the broadcast request is associated with broadcast content.

32. The method of claim 31, further comprising:
receiving payment based on transmitting the broadcast request.

33. The method of claim 32, further comprising:
generating a report based on transmitting the broadcast request to the broadcaster device and transmitting a plurality of additional broadcast requests.

34. The method of claim 33, further comprising:
accessing initiated content associated with the content initiation request based on the content initiation request,
wherein transmitting the broadcast request is based on the verification of the initiator and access of the initiated content.

35. The method of claim 34, further comprising:
identifying the initiator associated with the content initiation request,
wherein verification of the initiator is based on identification of the initiator.

36. The method of claim 35, further comprising:
selecting the initiated content based on receipt of the content initiation request,
wherein transmitting the broadcast request is based on the verification of the initiator and selection of the initiated content.

37. The method of claim 36, further comprising:
transmitting a broadcast request confirmation to the initiator device based on transmitting the broadcast request.

38. The method of claim 37, further comprising:
receiving a broadcast completion notification from the broadcaster device based on transmitting the broadcast request.

39. The method of claim 38, further comprising:
transmitting a broadcast confirmation to the initiator device based on receipt of the broadcast completion notification.

40. The method of claim 42, wherein the initiated content is selected from a group consisting of an animated graphic, crawling content, video and audio, and a static image.

41. The method of claim 43, wherein the initiated content is initiated advertising content.

42. A system for broadcasting content on demand comprising:
at least one processor;
at least one database to store user data and content, the user data comprising information regarding authorized initiators, the content comprising content that may be requested for broadcast by an authorized initiator; and
a plurality of modules executed by the processor to:
receive a content initiation request at a management device from an initiator device associated with an initiator, the initiator having initiated the content initiation request on the initiator device, the content initiation request being associated with initiated content and identifying a particular initiator;
verify the particular initiator associated with the content initiation request is an authorized initiator based on the user data;
identify broadcast time indicia from the content initiation request;
transmit a broadcast request to a broadcaster device when the particular initiator is verified, the broadcast request associated with the initiated content and comprising the broadcast time indicia; and
broadcast the initiated content via the broadcaster device based on the broadcast time indicia.

43. The system of claim 42, wherein the content initiation request identifies the initiated content and the broadcast request includes a content identifier that identifies the initiated content.

44. The system of claim 42, wherein the content initiation request includes the initiated content.

45. The system of claim 42 wherein the broadcast request includes the initiated content.
